(19) United States
(12) Patent Application Publication
(10) Pub. No.: US 2026/0068020 A1
(43) Pub. Date: Mar. 5, 2026

(54) X-RAY GENERATION APPARATUS AND X-RAY IMAGING APPARATUS

(71) Applicant: CANON ANELVA CORPORATION, Kawasaki-shi (JP)

(72) Inventor: Junya KAWASE, Kanagawa (JP)

(73) Assignee: CANON ANELVA CORPORATION, Kawasaki-shi (JP)

(21) Appl. No.: 19/377,630

(22) Filed: Nov. 3, 2025

Related U.S. Application Data
(63) Continuation of application No. PCT/JP2024/031347, filed on Aug. 30, 2024.

(30) Foreign Application Priority Data
Sep. 13, 2023 (WO) PCT/JP2023/033421

(51) Int. Cl. H05G 1/04; G01N 23/04

(52) U.S. Cl. CPC H05G 1/04; G01N 23/04

(57) ABSTRACT

X-ray generation apparatus includes X-ray generation tube including cathode and anode; accommodating container including first portion forming first space, second portion having smaller width than the first space and arranged to surround at least part of the X-ray generation tube, thereby forming second space, and connecting portion connecting the first portion and the second portion to each other to form internal space and including convex portion pointed toward the internal space; first insulating portion arranged between the convex portion and the X-ray generation tube and surrounding the X-ray generation tube; and second insulating portion arranged to be in contact with at least portion of the X-ray generation tube and surrounding the X-ray generation tube, wherein outer diameter of the second insulating portion is larger than inner diameter of the first insulating portion.

### CROSS-REFERENCE TO RELATED APPLICATIONS

This application is a Continuation of International Application No. PCT/JP2024/031347, filed Aug. 30, 2024, which claims the benefit of International Application No. PCT/JP2023/033421, filed Sep. 13, 2023, both of which are hereby incorporated by reference herein in their entirety.

### BACKGROUND

### Field of the Technology

The present invention relates to an X-ray generation apparatus and an X-ray imaging apparatus.

### Description of the Related Art

The enlargement ratio of an X-ray fluoroscopic image can increase as the distance between a subject and an X-ray generation unit formed on a target is short. There is known an X-ray generation apparatus in which to obtain a sufficient enlargement ratio even in a case in which the subject is located at a deep position, a projecting portion long projecting from the main body portion of an accommodating container is provided on the main body portion, and an X-ray generation unit is attached to the distal end of the projecting portion. Such an X-ray generation apparatus is described in Japanese Patent Laid-Open No. 2018-73625.

Japanese Patent Laid-Open No. 2018-73625 describes an X-ray generation apparatus including an X-ray generation tube, and an accommodating container that accommodates the X-ray generation tube. The X-ray generation tube includes an anode, a cathode including an electron emitting source, and an insulating tube that forms a vacuum space between the anode and the cathode. The anode is electrically connected to the accommodating container. The accommodating container includes a rear accommodating portion, a flange portion that approaches the insulating tube of the X-ray generation tube from a portion continued from the rear accommodating portion and surrounds the insulating tube, and a projecting portion projecting from the flange portion. The anode of the X-ray generation tube is fixed to the projecting portion. An annular bending portion is formed between the projecting portion and the flange portion. A protective member is arranged between the cathode of the X-ray generation tube and the annular bending portion. The protective member is an annular member formed by rotating an L-shaped section.

If a protective member as described in Japanese Patent Laid-Open No. 2018-73625 is provided, a gap between the protective member and the insulating tube of an X-ray tube decreases. Experiments by the present applicant have revealed a problem that the decreased gap leads to the increased electric field of an insulating oil existing in the gap, and this caused discharge between the cathode and anode of the X-ray tube. An arrangement where the protective member is extended to the cathode side of the X-ray tube to physically block the discharge path between the cathode and the anode is unsuitable because poor filling of the insulating oil to the distal end of the projecting portion occurs in the manufacture of the X-ray tube.

### SUMMARY

The embodiments include a technique advantageous for preventing discharge between the cathode and anode of an X-ray tube and for facilitating application of an insulating oil to the distal end of the projecting portion in the manufacture.

A first aspect of the embodiments is directed to an X-ray generation apparatus, and the X-ray generation apparatus comprises: an X-ray generation tube including an insulating tube with a first opening end and a second opening end, a cathode arranged to close the first opening end and including an electron emitting portion that emits electrons in a first direction, and an anode arranged to close the second opening end and including a target that generates X-rays when electrons radiated from the electron emitting portion collide; an accommodating container including a first portion forming a first space, a second portion having a smaller width in a second direction orthogonal to the first direction than the first space and arranged to surround at least a part of the X-ray generation tube, thereby forming a second space, and a connecting portion connecting the first portion and the second portion to each other to form an internal space in which the first space and the second space communicate, the connecting portion including a convex portion pointed toward the internal space; a first insulating portion arranged between the convex portion and the X-ray generation tube to be spaced apart from the X-ray generation tube, and surrounding the X-ray generation tube; and a second insulating portion arranged to be in contact with at least a portion of the X-ray generation tube and be spaced apart from the first insulating portion, and surrounding the X-ray generation tube, wherein an outer diameter of the second insulating portion is larger than an inner diameter of the first insulating portion.

A second aspect of the embodiments is directed to an X-ray imaging apparatus, and the X-ray imaging apparatus comprises: an X-ray generation apparatus according to the first aspect; and an X-ray detection apparatus configured to detect X-rays radiated from the X-ray generation apparatus and transmitted through an object.

### BRIEF DESCRIPTION OF DRAWINGS

FIG. 1 is a view showing the arrangement of an X-ray generation apparatus according to the first embodiment;

FIG. 2 is a view showing the arrangement of an X-ray imaging apparatus according to an embodiment;

FIG. 3 is a view showing the arrangement of an X-ray generation apparatus according to the second embodiment;

FIG. 4 is a view showing the arrangement of the X-ray generation apparatus according to the second embodiment;

FIG. 5 is a view showing the arrangement of an X-ray generation apparatus according to the third embodiment;

FIG. 6A is a view showing the arrangement of the X-ray generation apparatus according to the third embodiment;

FIG. 6B is an enlarged view of a part of FIG. 6A;

FIG. 7A is a view showing the arrangement of the X-ray generation apparatus according to the third embodiment;

FIG. 7B is an enlarged view of a part of FIG. 7A;

FIG. 8A is a view showing the arrangement of the X-ray generation apparatus according to the third embodiment; and

FIG. 8B is an enlarged view of a part of FIG. 8A.

### DESCRIPTION OF EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

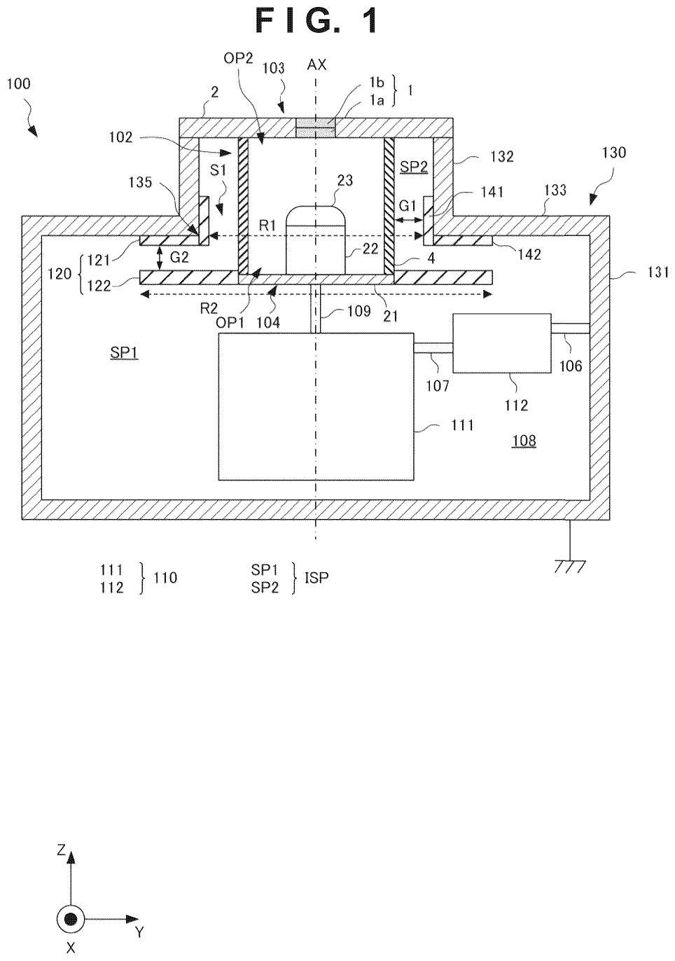

FIG. 1 schematically shows the arrangement of an X-ray generation apparatus 100 according to the first embodiment. The X-ray generation apparatus 100 can include an X-ray generation tube 102, a voltage supply unit 110, an accommodating container 130, an insulating liquid 108, and an insulating structure 120. FIG. 1 shows a section along a virtual plane including a tube axis AX of the X-ray generation tube 102. The X-ray generation tube 102 can include a cathode 104 including an electron emitting portion 23 that emits electrons in the first direction (Z direction), which is a direction parallel to the tube axis AX, and an anode 103 including a target 1 that generates X-rays when the electrons radiated from the electron emitting portion 23 collide. The X-ray generation tube 102 can also include an insulating tube 4 that forms a part of the outer surface of the X-ray generation tube 102. The insulating tube 4 can have a first opening end OP1 and a second opening end OP2. The cathode 104 can be arranged to close the first opening end OP1. The anode 103 can be arranged to close the second opening end OP2. The insulating tube 4 can have a tubular shape such as a cylindrical shape. The insulating tube 4 can be configured to provide vacuum airtightness and insulating properties of the internal space of the insulating tube 4. The insulating tube 4 can be made of, for example, a ceramic material mainly containing alumina or zirconia. Alternatively, the insulating tube 4 can be made of a glass material such as borosilicate glass. The voltage supply unit 110 supplies a voltage to the X-ray generation tube 102, more specifically, to the cathode 104 via a conductive line 109. The conductive line 109 can include a conductive member and an insulating member that covers the conductive member, but may not include the insulating member.

The accommodating container 130 can include a first portion 131, a second portion 132, and a connecting portion 133. The first portion 131 can be arranged to surround at least a part of the side surface of the X-ray generation tube 102, thereby forming a first space SP1. The first portion 131 can accommodate the voltage supply unit 110. The second portion 132 can be arranged to surround the other part of the side surface of the X-ray generation tube 102, thereby forming a second space SP2. The connecting portion 133 can connect the first portion 131 and the second portion 132 to each other to form an internal space ISP in which the first space SP1 formed by the first portion 131 and the second space SP2 formed by the second portion 132 communicate. The width of the second portion 132 in the second direction (Y direction) orthogonal to the first direction (Z direction) is smaller than that of the first portion 131. In addition, the width of the second space SP2 in the second direction (Y direction) orthogonal to the first direction (Z direction) is smaller than that of the first space SP1.

In the section along the virtual plane including the tube axis AX of the X-ray generation tube 102, the connecting portion 133 can include a convex portion 135 pointed toward the internal space ISP of the accommodating container 130. The second portion 132 can have, for example, a tubular shape such as a cylindrical shape. In the section along the virtual plane including the tube axis AX of the X-ray generation tube 102 as shown in FIG. 1, the convex portion 135 may have an internal angle of 90° or an acute internal angle or an obtuse internal angle. A structure is provided in which the convex portion 135 is arranged between the cathode 104 and the anode 103 in the first direction (Z direction). In the example shown in FIG. 1, the length of the second portion 132 in the first direction is longer than the length of the X-ray generation tube 102 in the first direction.

The insulating liquid 108 can fill the internal space ISP of the accommodating container 130 to be in contact with the cathode 104 and surround the conductive line 109. The insulating structure 120 can be arranged in the internal space ISP of the accommodating container 130 to surround at least a portion of the insulating tube 4. Additionally, the insulating structure 120 can be arranged in the internal space ISP of the accommodating container 130 to surround at least a portion of the cathode 104. The insulating structure 120 can include a first insulating portion 121 and a second insulating portion 122. The first insulating portion 121 and the second insulating portion 122 can be arranged spaced apart from each other in the first direction (Z direction).

The first insulating portion 121 is arranged between the convex portion 135 and the X-ray generation tube 102 to be in contact with the convex portion 135 and be spaced apart from the X-ray generation tube 102, thereby surrounding the X-ray generation tube 102. The first insulating portion 121 can be arranged to block at least the shortest path between the insulating tube 4 and the convex portion 135 of the connecting portion 133. The first insulating portion 121 can be arranged to block the linear path between the insulating tube 4 and the convex portion 135 of the connecting portion 133 in the entire insulating tube 4. In a case where the first insulating portion 121 is arranged to block the linear path between the insulating tube 4 and the convex portion 135 of the connecting portion 133 in the entire insulating tube 4, the first insulating portion 121 and the convex portion 135 may not be in contact with each other. Additionally, the first insulating portion 121 can be arranged to block the linear path between the convex portion 135 of the connecting portion 133 and a cathode member 21 of the cathode 104 forming a part of the outer surface of the X-ray generation tube 102. In (a sectional view of) a plane orthogonal to the first direction (Z direction), at least a part of the insulating tube 4 can be arranged to face the first insulating portion 121.

The arrangement in which the first insulating portion 121 is in contact with the convex portion 135 or the accommodating container 130 is advantageous for increasing a gap G1 between the first insulating portion 121 and the insulating tube 4, and a gap G2 between the first insulating portion 121 and the second insulating portion 122. By increasing the gaps G1 and G2, the conductance of the insulating liquid 108 from the first space SP1 to the second space SP2 upon filling of the insulating liquid 108 increases, so that the insulating liquid 108 can be filled into the entire second space SP2. The gap G1 is desirably larger than the gap G2. In addition, by increasing the gaps G1 and G2, the electric fields in the gaps G1 and G2 can be decreased.

The second insulating portion 122 is arranged to be in contact with at least a portion of the cathode 104 and be spaced apart from the first insulating portion 121, thereby surrounding the cathode 104. Here, at least a portion of the cathode 104, for example, the cathode member 21 can be arranged to be in contact with the second insulating portion 122. The second insulating portion 122 can be arranged to be in contact with both of at least a portion of the cathode member 21 and at least a portion of the insulating tube 4. From another viewpoint, the second insulating portion 122 can be arranged to be in contact with the boundary surface (contact portion) between the cathode member 21 and the insulating tube 4. Furthermore, the second insulating portion 122 is desirably in contact with the entire boundary surface (contact portion) between the cathode member 21 and the insulating tube 4, thereby surrounding the boundary surface (contact portion).

The first insulating portion 121 has an opening S1 with an inner diameter R1. The second insulating portion 122 has an outer diameter R2. R2 is desirably larger than R1. This can increase the discharge distance between a portion of the cathode member 21 not covered with the second insulating portion 122 and a portion of the second portion 132 not covered with the first insulating portion 121, thereby preventing abnormal discharge. At least a part of the X-ray generation tube 102 can be arranged in the opening S1. From another viewpoint, the X-ray generation tube 102 can be arranged to extend through the opening S1. From still another viewpoint, the insulating tube 4 of the X-ray generation tube 102 can be arranged to extend through the opening S1.

The first insulating portion 121 can include a cylindrical portion 141 with the inner diameter R1, and a ring portion 142 spreading in a radial direction from a portion (for example, one end) of the cylindrical portion 141. The central axis of the cylindrical portion 141 and the central axis of the ring portion 142 can coincide with each other. From another viewpoint, the central axis of the cylindrical portion 141 and the central axis of the ring portion 142 can coincide with tube axis AX of the X-ray generation tube 102. The second insulating portion 121 can be formed by a ring portion arranged parallel to the ring portion 142 of the first insulating portion 121. The central axis of the second insulating portion 121 can coincide with the central axis of the cylindrical portion 141 and the central axis of the ring portion 142. From another viewpoint, the central axis of the second insulating portion 121 can coincide with the tube axis AX of the X-ray generation tube 102.

Each of the first insulating portion 121 and the second insulating portion 122 need only be an insulating solid, and can be made of, for example, a material selected from a ceramic, a glass material, a resin material using glass epoxy or polycarbonate, and the like. Each of the first insulating portion 121 and the second insulating portion 122 preferably has an insulation property of 1×10⁵ Ωm or more in a volume resistance at 25° C.

The target 1 of the X-ray generation tube 102 accommodated in the second portion 132 can be located at the distal end (the upper end in FIG. 1) of the second portion 132. The X-ray generation tube 102 can be a transmission-type X-ray generation tube. In the X-ray generation tube 102, the anode 103, the cathode member 21, and the insulating tube 4 constitute a vacuum airtight container. The insulating tube 4 has a tubular shape, for example, a cylindrical shape, and connects the anode 103 and the cathode 104 while insulating them from each other. The anode 103 can include the target 1 and an anode member 2. The target 1 can include a target layer 1a, and a support window 1b that supports the target layer 1a. The anode member 2 can have an annular shape. The anode member 2 supports the target 1. The anode member 2 can electrically be connected to the target layer 1a. The anode member 2 and the support window 1b can be connected by, for example, a brazing material. In the example shown in FIG. 1, the target 1 and the distal end of the second portion 132 are arranged on the same plane. However, the target 1 may be arranged to project outward from the distal end of the second portion 132 or may be arranged to be recessed from the distal end of the second portion 132 as long as the target 1 is set at the same potential as the second portion 132 (that is, grounded). The form in which the target 1 is located at the distal end of the second portion 132 can include such a form as well.

The target layer 1a contains, for example, a heavy metal such as tungsten or tantalum, and generates X-rays when irradiated with electrons. The thickness of the target layer 1a can be decided based on the balance between the electron penetration length that contributes to generation of X-rays and the self-attenuation amount when the generated X-rays pass through the support window 1b. The thickness of the target layer 1a can fall within the range of, for example, 1 μm to several ten μm.

The support window 1b has a function of passing the X-rays generated in the target layer 1a and discharging them out of the X-ray generation tube 102. The support window 1b can be made of a material that passes X-rays, for example, beryllium, aluminum, silicon nitride, or an allotrope of carbon. To effectively transmit heat generated in the target layer 1a to the anode member 2, the support window 1b can be made of, for example, diamond that has a high heat conductivity.

The insulating tube 4 can be made of a ceramic material such as alumina or zirconia having vacuum airtightness and insulating properties, soda lime, or a glass material such as silica. From a viewpoint of reducing the thermal stress with respect to the insulating tube 4, the cathode member 21 and the anode member 2 can be made of materials having linear expansion coefficients αc (ppm/° C.) and αa (ppm/° C.), respectively, which are close to a linear expansion coefficient αi (ppm/° C.) of the insulating tube 4. The cathode member 21 and the anode member 2 can be made of, for example, an alloy such as Kovar or Monel.

The cathode 104 can include the electron emitting portion 23, the cathode member 21 forming a part of the outer surface of the X-ray generation tube 102, and a fixing portion 22 that fixes the electron emitting portion 23 to the cathode member 21. For example, to the cathode member 21, the electron emitting portion 23 may be connected via a brazing material, may thermally be fused by laser welding or the like, or may electrically be connected by another method. The electron emitting portion 23 can include an electron source such as an impregnated type thermion source, a filament type thermion source, or a cold cathode electron source. The electron emitting portion 23 can include an electrostatic lens electrode (not shown) such as an extraction grid electrode or a focusing lens electrode, which defines an electrostatic field. The fixing portion 22 can have a tubular shape that passes the conductive line 109 electrically connected to the electron source and the electrostatic lens electrode. The conductive line 109 can include a plurality of conductive members insulated from each other.

The X-ray generation apparatus 100 can be formed as an anode grounded type in which the anode 103 is grounded. In the anode grounded type, the anode 103 can electrically be connected to the accommodating container 130. The accommodating container 130 can electrically be connected to a ground terminal 105. The cathode 104 can electrically be connected to the voltage supply unit 110 via the conductive line 109.

The voltage supply unit 110 can include a power supply circuit 111, and a driving circuit 112 that receives power supplied from the power supply circuit 111 via a power supply line 107 and drives the X-ray generation tube 102 via the conductive line 109. The driving circuit 112 can electrically be connected to the accommodating container 130 via the power supply line 107, the power supply circuit 111, and a grounding wire 106. The driving circuit 112 can control the emitted electron amount from the electron source or the electron beam diameter by controlling voltages to be supplied to the electron source, the extraction grid electrode, the focusing lens electrode, and the like. The positive electrode terminal of the power supply circuit 111 is grounded via the grounding wire 106 and the accommodating container 130, and the negative electrode terminal of the power supply circuit 111 is connected to the driving circuit 112 via the power supply line 107 to supply a negative voltage to the driving circuit 112. A control signal can be supplied to the driving circuit 112 from, for example, a control unit (not shown) arranged outside the accommodating container 130 via a cable such as an optical fiber cable.

The first portion 131, the second portion 132, and the connecting portion 133, which form the accommodating container 130, can be made of a material with conductivity, electrically connected to each other, and grounded. This arrangement is advantageous in ensuring electrical safety. The first portion 131, the second portion 132, and the connecting portion 133 can be made of a metal material. The insulating liquid 108 can vacuum-fill the accommodating container 130. The reason for this is that if bubbles exist in the insulating liquid 108, a region whose dielectric constant is lower as compared to the insulating liquid 108 on the periphery is locally formed, resulting in discharge.

The insulating liquid 108 also has a function of suppressing discharge between the X-ray generation tube 102 and the accommodating container 130 and discharge between the voltage supply unit 110 (the power supply circuit 111 and the driving circuit 112) and the accommodating container 130. As the insulating liquid 108, a liquid having excellent heat resistance, liquidity, and electrical insulating properties in the operating temperature range of the X-ray generation apparatus 100, for example, a chemical synthetic oil such as silicone oil or fluororesin-based oil, a mineral oil, or the like can be used.

The X-ray generation tube 102 can be joined to the opening portion provided at the distal end (the lower end in FIG. 1) of the second portion 132 of the accommodating container 130 and thus fixed to the second portion 132. The space between the X-ray generation tube 102 and the inner side surface of the second portion 132 can be filled with the insulating liquid 108. The power supply circuit 111 and the driving circuit 112 can be fixed to the first portion 131 of the accommodating container 130 by a fixing member (not shown). The power supply circuit 111 and the driving circuit 112 can be surrounded by the insulating liquid 108. The conductive line 109 can be surrounded by the insulating liquid 108.

The connecting portion 133 of the accommodating container 130 includes, for example, a plate portion spreading in a direction orthogonal to the first direction (Z direction), and the plate portion includes an opening through which the X-ray generation tube 102 passes. The plate portion can contact the attachment surface of a structure (for example, a housing) that supports the X-ray generation apparatus 100. Alternatively, the plate portion can be fitted in the opening portion of the structure that supports the X-ray generation apparatus 100. In the accommodating container 130, the side surface of the opening of the plate portion and the inner side surface of the second portion 132 can form a continuous surface without a step. In an example, the opening of the plate portion can be a circular opening, and the inner side surface of the second portion 132 can be a cylindrical surface. The convex portion 135 can be formed by the end of the opening of the plate portion.

Note that there is a method in which the dimension of the opening that defines the convex portion 135 is made large, thereby increasing the distance between the convex portion 135 and the cathode 104. However, this method is not preferable because it leads to an increase in the size of the X-ray generation apparatus 100.

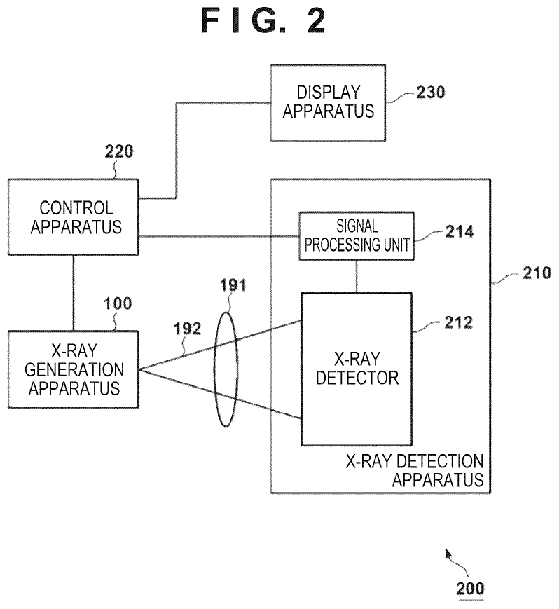

FIG. 2 shows the arrangement of an X-ray imaging apparatus 200 according to an embodiment. The X-ray imaging apparatus 200 can include the X-ray generation apparatus 100, and an X-ray detection apparatus 210 that detects X-rays 192 radiated from the X-ray generation apparatus 100 and transmitted through an object 191. The X-ray imaging apparatus 200 may further include a control apparatus 220 and a display apparatus 230. The X-ray detection apparatus 210 can include an X-ray detector 212 and a signal processing unit 214. The control apparatus 220 can control the X-ray generation apparatus 100 and the X-ray detection apparatus 210. The X-ray detector 212 detects or captures the X-rays 192 radiated from the X-ray generation apparatus 100 and transmitted through the object 191. The signal processing unit 214 can process a signal output from the X-ray detector 212 and supply the processed signal to the control apparatus 220. The control apparatus 220 causes the display apparatus 230 to display an image based on the signal supplied from the signal processing unit 214.

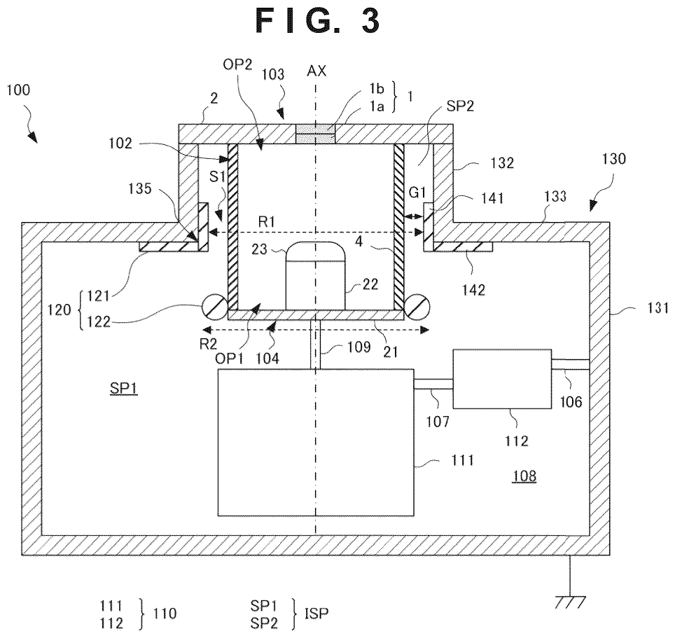

FIG. 3 exemplarily and schematically shows the arrangement of an X-ray generation apparatus 100 according to the second embodiment. Matters not mentioned as the second embodiment can follow the first embodiment. In the second embodiment, a second insulating portion 122 can be a ring-shaped portion, or can have a shape including a ring-shaped portion. From another viewpoint, the second insulating portion 122 can have a circular section. The ring-shaped portion can surround the whole periphery of a part (a part in a direction along a tube axis AX) of a cathode 104. The second insulating portion 122 can be made of, for example, a rubber material represented by nitrile rubber, fluororubber, synthetic rubber, or the like. The second insulating portion 122 can be formed by an O-ring. Also in the second embodiment, an outer diameter R2 of the second insulating portion 122 is desirably larger than an inner diameter R1 of a first insulating portion 121. The second insulating portion 122 can be arranged in a first space SP1. The first insulating portion 121 and the second insulating portion 122 can be arranged to be not in contact with each other.

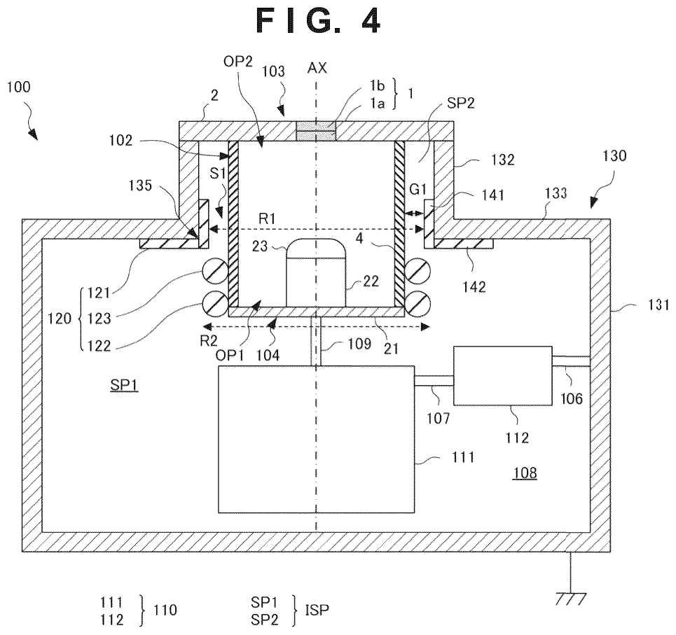

If the second insulating portion 122 is formed by an O-ring, since the O-ring has a circular section, the contact area between the second insulating portion 122 and the cathode 104 can be small. In this case, as exemplified in FIG. 4, an insulating structure 120 may include a third insulating portion 123 between the second insulating portion 122 and the first insulating portion 121 in a direction parallel to the tube axis AX of the X-ray generation tube. The third insulating portion 123 can be arranged around the insulating tube 4 between the cathode 104 and the first insulating portion 121. The third insulating portion 123 may have the same arrangement as the second insulating portion 122, or may have an arrangement different from that of the second insulating portion 122. The outer diameter of the third insulating portion 123 is desirably larger than the inner diameter R1 of the first insulating portion 121.

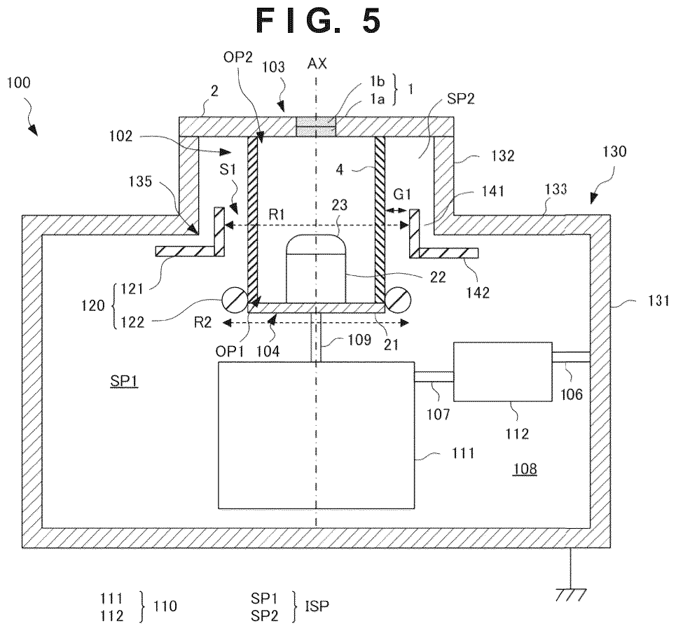

FIG. 5 exemplarily and schematically shows the arrangement of an X-ray generation apparatus 100 according to the third embodiment. The third embodiment is a modification of the second embodiment, and matters not mentioned as the third embodiment can follow the first embodiment or the second embodiment. In the third embodiment, it is intended to increase the dimension of a second space SP2 in the second direction (Y direction) to improve the dielectric breakdown voltage. To satisfy R2>R1, a first insulating portion 121 may be arranged spaced apart from a convex portion 135. The third embodiment is more advantageous for implementing a high dielectric breakdown voltage than the second embodiment. Since the first insulating portion 121 and the convex portion 135 are spaced apart from each other, an insulating liquid 108 easily flows between a first space SP1 and the second space SP2. With this, the heat generated by an X-ray generation tube 102 can be efficiently exhausted to the outside of the X-ray generation apparatus 100 via the insulating liquid 108.

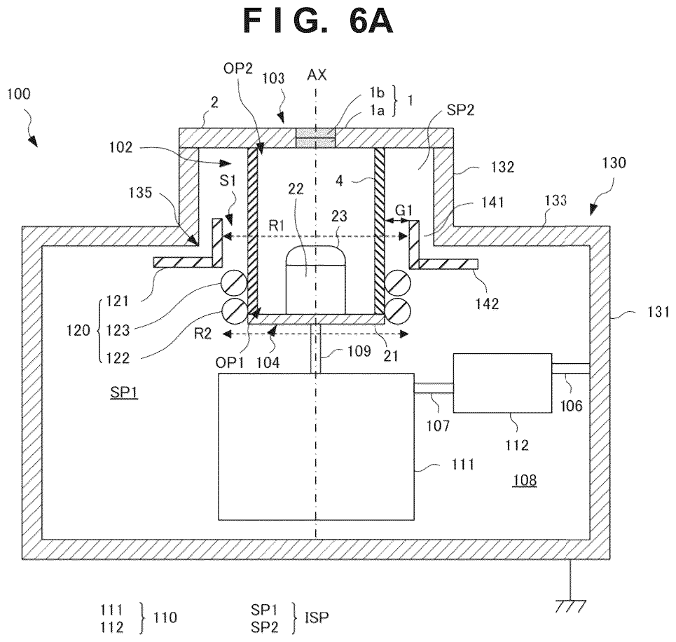

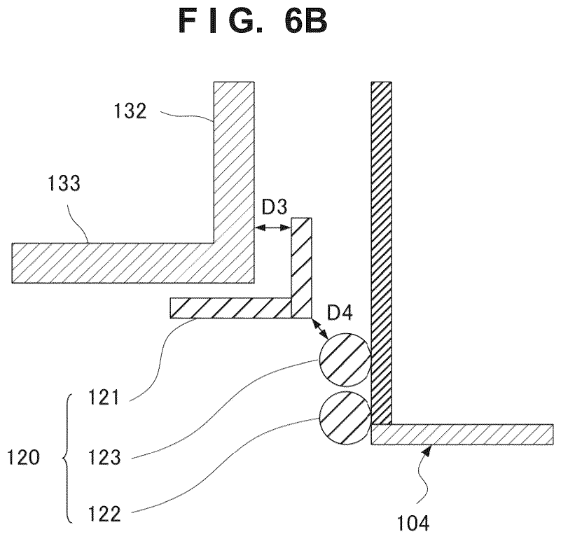

Similar to the second embodiment, a third insulating portion 123 may be provided as exemplified in FIGS. 6A and 6B. The third insulating portion 123 decreases the amount of the insulating liquid 108 moving through a gap between the first insulating portion 121 and the X-ray generation tube 102. However, this problem can be alleviated by the insulating liquid 108 moving through a gap between the first insulating portion 121 and an accommodation container 130. In addition, in the example shown in FIGS. 6A and 6B, since charging by friction between the insulating liquid 108 and an insulating tube 4 decreases, abnormal discharge between the insulating tube 4 and the accommodating container 130 or between the insulating tube 4 and the first insulating portion 121 can be suppressed. Such suppression of abnormal discharge is also expected in a structure where the second insulating portion 122 is not provided. Hence, in the arrangement where the first insulating portion 121 and the convex portion 135 are spaced apart from each other, the third insulating portion 123 may be provided around the insulating tube 4 between a cathode 104 and the first insulating portion 121 without providing the second insulating portion 122. A shortest distance D4 between the third insulating portion 123 and the first insulating portion 121 is desirably smaller than a shortest distance D3 between the first insulating portion 121 and the accommodating container 130.

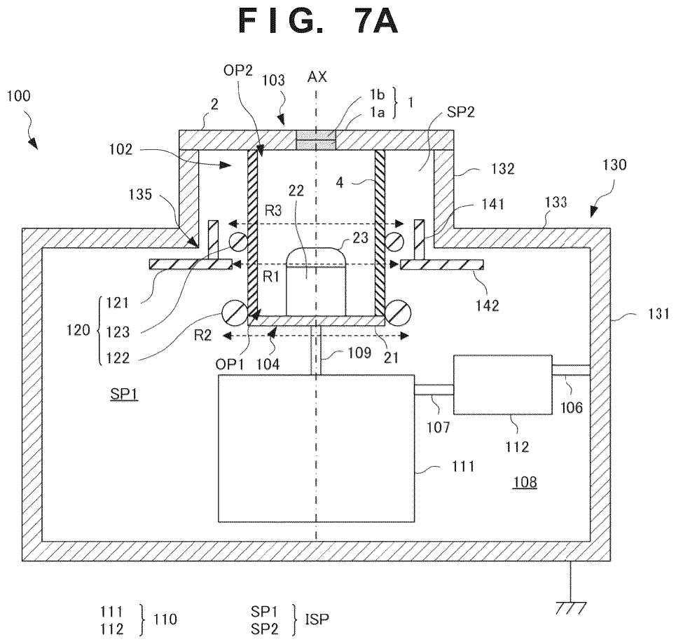

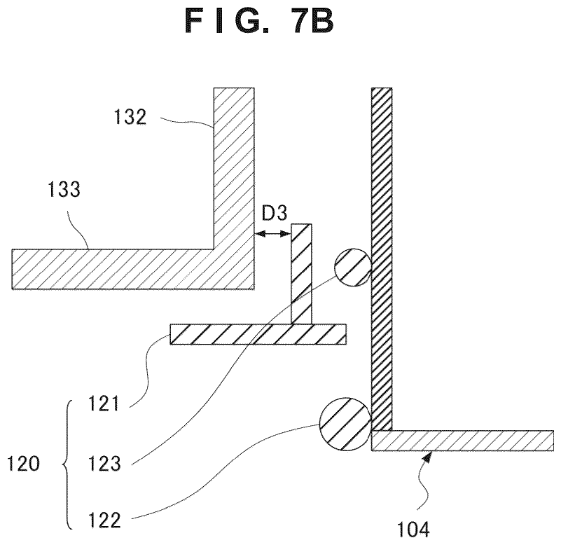

The third insulating portion 123 may be arranged as exemplified in FIGS. 7A and 7B. The first insulating portion 121 can include a cylindrical portion 141 and a ring portion 142. The third insulating portion 123 can be arranged between the cylindrical portion 141 and the insulating tube 4. In other words, the insulating tube 4 includes a region facing the cylindrical portion 141 in the second direction, and the third insulating portion 123 can be arranged around this region. From another viewpoint, the third insulating portion 123 can be arranged around a region facing the cylindrical portion 141 in the second direction. Here, arranging the third insulating portion 123 around a region includes arranging the third insulating portion 123 to be in contact with the region. To implement an arrangement where an outer diameter R3 of the third insulating portion 123 is larger than an inner diameter (minimum inner diameter) R1 of the first insulating portion 121, the inner diameter of the ring portion 142 can be made smaller than the inner diameter of the cylindrical portion 141. With this structure, it becomes difficult for the insulating liquid 108 to move through a gap between the first insulating portion 121 and the X-ray generation tube 102. This can reduce charging by friction between the insulating liquid 108 and the insulating tube 4, thereby suppressing abnormal discharge between the insulating tube 4 and the accommodating container 130 or between the insulating tube 4 and the first insulating portion 121.

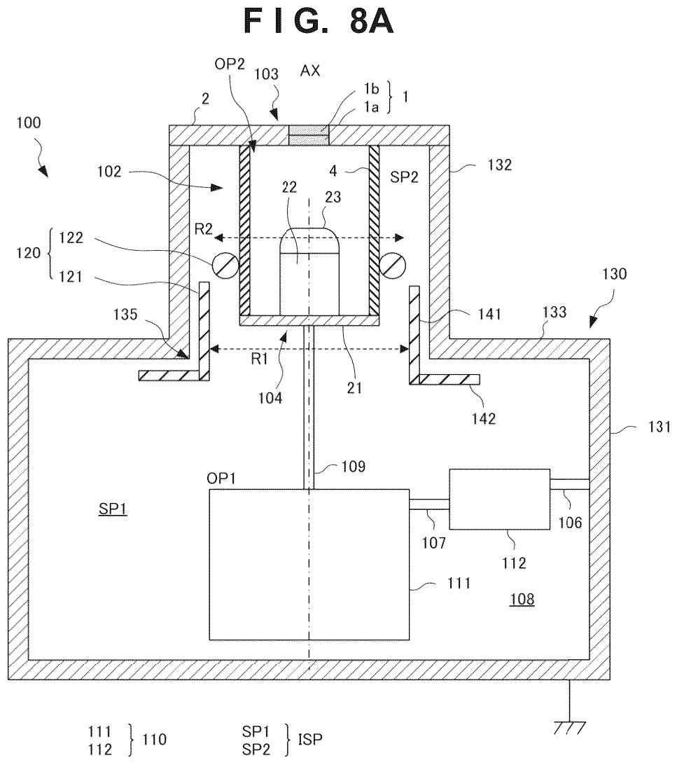

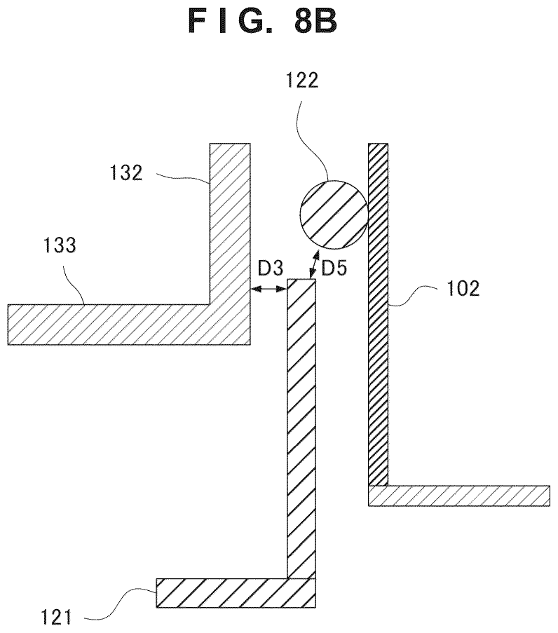

FIGS. 8A and 8B exemplarily and schematically show the arrangement of an X-ray generation apparatus 100 according to the fourth embodiment. Matters not mentioned as the fourth embodiment can follow the first to third embodiments. In the fourth embodiment, an X-ray generation tube 102 is entirely surrounded by a second portion 132. Alternatively, in the fourth embodiment, an insulating tube 4 is entirely surrounded by the second portion 132. In this arrangement, a second insulating portion 122 is desirably provided between a first insulating portion 121 and an anode 103. The second insulating portion 122 can be arranged to be in contact with the insulating tube 4. An outer diameter R2 of the second insulating portion 122 is desirably larger than an inner diameter R1 of the first insulating portion 121. A shortest distance D5 between the second insulating portion 122 and the first insulating portion 121 is desirably smaller than a shortest distance D3 between the first insulating portion 121 and an accommodating container 130.

In the arrangement shown in each of FIGS. 4, 6A, and 7A, both the second insulating portion 122 and the third insulating portion 123 are provided. However, providing the second insulating portion 122 is not essential. That is, the effect of decreasing the conductance between the first insulating portion 121 and the X-ray generation tube 102, that is, reducing the flow of the insulating liquid 108 through the gap between the first insulating portion 121 and the X-ray generation tube 102 and reducing charging by friction between the insulating liquid 108 and the insulating tube 4, thereby suppressing abnormal discharge between the insulating tube 4 and the accommodating container 130 or between the insulating tube 4 and the first insulating portion 121 is also provided by the arrangement without the second insulating portion 122.

The present invention is not limited to the above embodiments and various changes and modifications can be made within the spirit and scope of the present invention. Therefore, to apprise the public of the scope of the present invention, the following claims are made.

1. An X-ray generation apparatus comprising:
an X-ray generation tube including an insulating tube with a first opening end and a second opening end, a cathode arranged to close the first opening end and including an electron emitting portion that emits electrons in a first direction, and an anode arranged to close the second opening end and including a target that generates X-rays when electrons radiated from the electron emitting portion collide;
an accommodating container including a first portion forming a first space, a second portion having a smaller width in a second direction orthogonal to the first direction than the first space and arranged to surround at least a part of the X-ray generation tube, thereby forming a second space, and a connecting portion connecting the first portion and the second portion to each other to form an internal space in which the first space and the second space communicate, the connecting portion including a convex portion pointed toward the internal space;
a first insulating portion arranged between the convex portion and the X-ray generation tube to be spaced apart from the X-ray generation tube, and surrounding the X-ray generation tube; and
a second insulating portion arranged to be in contact with at least a portion of the X-ray generation tube and be spaced apart from the first insulating portion, and surrounding the X-ray generation tube,
wherein an outer diameter of the second insulating portion is larger than an inner diameter of the first insulating portion.

2. The X-ray generation apparatus according to claim 1, wherein
the first insulating portion is arranged to block a linear path between the insulating tube and the convex portion in the entire insulating tube.

3. The X-ray generation apparatus according to claim 1, wherein
a length of the second portion in the first direction is shorter than a length of the X-ray generation tube in the first direction.

4. The X-ray generation apparatus according to claim 1, wherein
a length of the second portion in the first direction is longer than a length of the X-ray generation tube in the first direction.

5. The X-ray generation apparatus according to claim 1, wherein
the second insulating portion is made of a rubber material.

6. The X-ray generation apparatus according to claim 3, wherein
the X-ray generation tube includes a cathode member forming a part of an outer surface of the X-ray generation tube, and
the second insulating portion is provided around the insulating tube between the first insulating portion and the cathode member.

7. The X-ray generation apparatus according to claim 1, wherein
the insulating tube includes a region facing the first insulating portion in the second direction, and
the second insulating portion is arranged around the region.

8. The X-ray generation apparatus according to claim 1, wherein
the second insulating portion is arranged between the first insulating portion and the anode, and
the second insulating portion is in contact with the insulating tube.

9. The X-ray generation apparatus according to claim 1, wherein
the first insulating portion includes a cylindrical portion, and a ring portion spreading in a radial direction from a part of the cylindrical portion.

10. The X-ray generation apparatus according to claim 1, wherein
the second insulating portion has a circular section.

11. The X-ray generation apparatus according to claim 1, wherein
the X-ray generation tube is a transmission-type X-ray generation tube.

12. The X-ray generation apparatus according to claim 1, wherein
the first insulating portion and the convex portion are in a noncontact relationship.

13. The X-ray generation apparatus according to claim 1, wherein
a shortest distance between the first insulating portion and the second insulating portion is smaller than a shortest distance between the first insulating portion and the accommodating container.

14. The X-ray generation apparatus according to claim 3, comprising
a third insulating portion arranged around the cathode.

15. The X-ray generation apparatus according to claim 1, further comprising
an insulating liquid filled in the internal space.

16. An X-ray imaging apparatus comprising:
an X-ray generation apparatus defined in claim 1; and
an X-ray detection apparatus configured to detect X-rays radiated from the X-ray generation apparatus and transmitted through an object.
